(19) United States
(12) Patent Application Publication
(10) Pub. No.: US 2008/0260507 A1
(43) Pub. Date: Oct. 23, 2008

(54) MODULAR AND COLLAPSIBLE STORAGE AND/OR TRANSPORT CONTAINER APPARATUS AND METHOD AND UTILITY TRAILER SYSTEM INCORPORATING THE SAME

(76) Inventor: Mark S. HERNANDEZ, Philadelphia, PA (US)

Correspondence Address: BUCHANAN, INGERSOLL & ROONEY PC, POST OFFICE BOX 1404, ALEXANDRIA, VA, 22313-1404, US

(21) Appl. No.: 12/105,138

(22) Filed: Apr. 17, 2008

Related U.S. Application Data
(63) Continuation-in-part of application No. 11/477,897, filed on Jun. 28, 2006.
(60) Provisional application No. 60/694,717, filed on Jun. 28, 2005.
(60) Provisional application No. 60/912,300, filed on Apr. 17, 2007.

(51) Int. Cl. B60P 9/00; B60P 1/04

(52) U.S. Cl. 414/462; 414/482

(57) ABSTRACT

A modular and collapsible container, including a trailer system and method utilizing the same. In one aspect, the invention is a container kit having an assembled state and disassembled state comprising: a floor section comprising a floor panel and a first perimeter frame connected to the floor panel so as to form a ridge extending above a surface of the floor panel; a roof section comprising a roof panel and a second perimeter frame connected to the roof panel so as to form a ridge extending below a surface of the floor panel; a plurality of posts comprising a first end and a second end; a plurality of panels; at least one door having hinges; a plurality of wheels; wherein when the container kit is in the disassembled state, the roof section stacks atop the floor section forming a cavity between the floor panel and the roof panel, and the plurality of posts, the plurality of panels, the at least one door, and the plurality of wheels are positioned within the cavity; and wherein when the container kit is in the assembled state, the floor section, the roof section, the plurality of posts, the plurality of panels, the at least one door, and the plurality of wheels form a stand-alone container defining a substantially enclosed volume. In another aspect, the invention is a system for storing and/or transporting articles comprising the aforementioned container kit and a utility trailer. In yet another aspect, the invention can be a method of shipping the aforementioned container kit in the disassembled state.

### CROSS-REFERENCE TO RELATED PATENT APPLICATIONS

The present application is a continuation-in-part of U.S. Non-Provisional patent application Ser. No. 11/477,897, filed Jun. 28, 2006, which in turn claims the benefit of U.S. Provisional Patent Application 60/694,717, filed Jun. 28, 2005, the entireties of which are hereby incorporated by reference. The present application claims the benefit of U.S. Provisional Patent Application 60/912,300, filed Apr. 17, 2007, the entirety of which is also hereby incorporated by reference.

### FIELD OF THE INVENTION

The present invention relates generally to modular containers used for transport and/or storage of goods, and specifically to a utility trailer system incorporating the same and a method of transporting the same.

### BACKGROUND OF THE INVENTION

There are devices that allow for the storage and transportation of various bulky items and the like. Utility trailers, for example, are typically coupled to trucks, cars or other vehicles and are used to transport various types of goods including automobiles, motorcycles, furniture, household goods and other items. Some utility trailers have protective enclosures, and can include a trailer bed having an undercarriage, axles and wheels attached thereto. A hitch, for connecting the trailer to a towing vehicle, is often times attached to the front of the trailer bed chassis. The protective enclosure is typically a box-like structure covering the trailer bed and secured to the chassis, which would include doors which permit access to the interior of the enclosure.

As an alternative to utility trailers, users may utilize rental trucks having permanently attached enclosures to transport items from location to location. There are, however, drawbacks in using utility trailers and rental trucks as previously described. In many instances, such utility trailers and trucks do not facilitate the extended storage of goods (rather, they facilitate the transportation of goods) and are bulky to situate in close proximity to, for example, a house or construction site. If a person desires to store goods for an extended period of time, such a person generally transports the person's goods to a storage facility and perhaps uses a utility trailer or rental truck to transport such goods.

There are stand-alone storage containers, however, that can be rented for a period of time (e.g., week, month). Such storage containers are handled and transported through special carrier frames systems, which are complex to operate. A person handling such a carrier frame would be in need of specialized training. Thus, the renter of such a stand-alone storage container would not be capable of operating such a carrier frame system without specialized training. Instead, a operator with specialized training is needed to handle and transport (usually in conjunction with a vehicle) such a stand-alone container. Generally, the entity supplying a stand-alone container would employ such an operator to handle and transport the rented container. Thus, one drawback is that a user is constrained by time and availability limitations of the operators employed by the entity supplying the storage containers as well as that of the carrier frame systems.

Another drawback is that normally such stand-alone containers are composed of a solid structure that takes up a significant amount of space. If such containers are no longer needed to store items, the containers cannot be easily dissembled. Instead the containers need to be both handled and removed by a specialty operator. Otherwise, the containers are not utilized and take up space. In addition, prior methods only contemplate the handling/transportation of one container per carrier frame system. For multiple containers, the carrier frame system and operator would have to repeat the process of securing the container at the original site, transporting the container to the new site, and returning the system to the original site for each container.

Accordingly, there is a need to have an improved containment system capable of storing goods that is easily transportable by the user at the discretion of the user as can be easily handled by such user.

### SUMMARY OF THE INVENTION

In view of the foregoing, it therefore an object of the present invention to provide a trailer frame capable of handling and transporting a container and a method of using the same.

Another object of the present invention to provide a trailer capable of easily handling and transporting a container, as well as a container that is easily handled and stored.

Yet another object of the present invention is to provide a trailer frame with a removable modular container.

Still another object of the present invention is to provide a trailer frame with a removable modular container that facilitates in the handling and transportation of goods

A further object of the present invention is to provide a container that can be easily assembled, disassembled and/or shipped.

A yet further object is to provide a method of shipping a modular container.

A still further object of the present invention is to provide a utility trailer system for transport and/or storage of goods that can be operated efficiently and with ease by an end user.

Another object of the present invention is to provide a trailer frame with removable container and a method of using the same.

Yet another object of the present invention is to provide a trailer frame with a removable container that facilitates in the handling and transportation of goods and a method of using the same.

These and other objects are addressed by the present invention, which is in one aspect can be a modular container capable of being secured to a trailer base and having an assembled state and disassembled state, the modular container comprising: a bottom panel assembly; an upper panel assembly removably stacked atop the bottom panel assembly to form a cavity when the modular container is in the disassembled state; at least one post comprising a first end and a second end, wherein the at least one post is capable of (i) being substantially contained within the cavity between the bottom panel assembly and the upper panel assembly when the modular container is in the disassembled state and (ii) being removably secured to the upper panel assembly at the first end and to the bottom panel assembly at the second end when the modular container is in the assembled state; and a plurality of panels capable of (i) being substantially contained within the cavity between the bottom panel assembly and the upper panel assembly when the modular container is in the disassembled state and (ii) being removably secured to the at least one post, the bottom panel assembly, the upper panel assembly or any combination thereof when the modular container is in the assembled state; whereby the upper panel assembly, the bottom panel assembly, the plurality of panels and at least one post create a stand-alone modular container defining a substantially enclosed volume when in the assembled state.

In another aspect, the invention can be a system for storing and/or transporting articles comprising: a modular container comprising: a bottom panel assembly; an upper panel assembly removably stacked atop the bottom panel assembly to form a cavity when the modular container is in a disassembled state; at least one post comprising a first end and a second end, wherein the at least one post is capable of (i) being substantially contained within the cavity between the bottom panel assembly and the upper panel assembly when the modular container is in the disassembled state and (ii) being removably secured to the upper panel assembly at the first end and to the bottom panel assembly at the second end when the modular container is in an assembled state; and a plurality of panels capable of (i) being substantially contained within the cavity between the bottom panel assembly and the upper panel assembly when the modular container is in the disassembled state and (ii) being removably secured to the at least one post, the bottom panel assembly, the upper panel assembly or any combination thereof when the modular container is in the assembled state; whereby the upper panel assembly, the bottom panel assembly, the plurality of panels and at least one post create a stand-alone modular container defining a substantially enclosed volume when in the assembled state; and a trailer comprising: a base frame; an upper frame comprising a rear end, a forward end, and slidably moving means to move the modular container in the assembled state along the length of the upper frame, the upper frame pivotally connected about a pivot point to the base frame; a winch assembly secured to the upper frame; and a hydraulic assembly pivotally mounted between the base frame and the upper frame, the hydraulic assembly adapted to move the upper frame relative to the base frame about the pivot point between a generally horizontal position and a tilted position, wherein the upper frame in the tilted position is adapted to receive the modular container in the assembled state through the slidably moving means.

In yet another aspect, the invention can be a container kit having an assembled state and disassembled state comprising: a floor section comprising a floor panel and a first perimeter frame connected to the floor panel so as to form a ridge extending above a surface of the floor panel; a roof section comprising a roof panel and a second perimeter frame connected to the roof panel so as to form a ridge extending below a surface of the floor panel; a plurality of posts comprising a first end and a second end; a plurality of panels; at least one door having hinges; a plurality of wheels; wherein when the container kit is in the disassembled state, the roof section stacks atop the floor section forming a cavity between the floor panel and the roof panel, and the plurality of posts, the plurality of panels, the at least one door, and the plurality of wheels are positioned within the cavity; and wherein when the container kit is in the assembled state, the floor section, the roof section, the plurality of posts, the plurality of panels, the at least one door, and the plurality of wheels form a stand-alone container defining a substantially enclosed volume.

In still another aspect, the invention can be a system for storing and/or transporting articles comprising: a container kit comprising: a floor section comprising a floor panel and a first perimeter frame connected to the floor panel so as to form a ridge extending above a surface of the floor panel; a roof section comprising a roof panel and a second perimeter frame connected to the roof panel so as to form a ridge extending below a surface of the floor panel; a plurality of posts comprising a first end and a second end; a plurality of panels; at least one door having hinges; a plurality of wheels; wherein when the container kit is in a disassembled state, the roof section stacks atop the floor section forming a cavity between the floor panel and the roof panel, and the plurality of posts, the plurality of panels, the at least one door, and the plurality of wheels are positioned within the cavity; and wherein when the container kit is in an assembled state, the floor section, the roof section, the plurality of posts, the plurality of panels, the at least one door, and the plurality of wheels form a stand-alone container defining a substantially enclosed volume; and a trailer comprising: a base frame; an upper frame comprising a rear end, a forward end, and a support surface, the upper frame pivotally connected about a pivot point to the base frame; at least two channels in the support surface for engaging the plurality of wheels of the stand-alone container, the at least two channels extending from at or near the rear end of the upper frame to at or near the forward end of the upper frame; a winch assembly secured to the upper frame; a hydraulic assembly comprising a piston rod and a powered hydraulic cylinder, the hydraulic assembly mounted between the base frame and the upper frame so that the piston rod is connected to the upper frame at or near the forward end and the-powered hydraulic cylinder is connected to the base frame, the hydraulic assembly adapted to move the upper frame about the pivot point between a generally horizontal position and a tilted position; a first set of wheels and a second set of wheels connected to the upper frame, the first set of wheels contacting a ground surface both when the upper frame is in the generally horizontal position and when the tipper frame is in the tilted position.

In a further aspect, the invention can be a trailer having a base frame; an upper frame comprising a rear end, a forward end, and slidably moving means to move a container along the length of the upper frame, the upper frame pivotally connected about a pivot point to the base frame; a winch assembly secured to the upper frame; and a hydraulic assembly pivotally mounted between the base frame and the upper frame, the hydraulic assembly adapted to move the upper frame relative to the base frame about the pivot point between a generally horizontal position and a tilted position, wherein the upper frame in the tilted position is adapted to receive a container through the slidably moving means. In one embodiment, the hydraulic assembly comprises a powered hydraulic cylinder and a piston rod operably connected to the powered hydraulic cylinder, the piston rod capable of being extended from the powered hydraulic cylinder.

In another embodiment, the slidably moving means comprises a channel to operably engage a wheel secured to the container when the upper frame is in the tilted position. Preferably the slidably moving means comprises two channels, each of the two channels capable of operably engaging a wheel secured to the container when the upper frame is in the tilted position. In such an embodiment, the winch assembly comprises a winch wire operably connected to a winch drum, the winch wire having a first end and a second end, wherein the winch wire at the first end is operably connected to the winch drum, the second end capable of being removably secured to the container, whereby the winch assembly actuates loading of the container onto the upper frame.

In yet another embodiment, the present invention further comprises a securing device secured to the base frame for removable connection to a vehicle. In a further embodiment, the present invention comprises a jack support connected to the base frame, the jack support comprising a support member slidably housed within a sleeve, the support member capable of being extended to a predetermined length, the support member at one end pivotally connected to a base capable of engaging the ground.

In another aspect, the present invention is a trailer assembly comprising a base frame; an upper frame comprising a rear end and a forward end, the upper frame pivotally connected about a pivot point to the base frame; a container removably secured to the upper frame, the container having a plurality of side walls, a roof, a floor, and a plurality of wheels connected to an exterior portion of the floor, wherein the upper frame further comprises slidably moving means to move the container along the length of the upper frame; a winch assembly secured to the upper frame, the winch assembly comprising a winch wire operably connected to a winch drum at one end of the winch wire, the other end of the winch wire capable of being removably secured to the container; and a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground, whereby, when the upper frame is in the tilted position, the winch assembly and the slidably moving means actuate loading of the container onto the upper frame or unloading of the container from the upper frame.

In one embodiment, the slidably moving means comprises a channel to operably engage a wheel secured to the container when the upper frame is in the tilted position. In a further embodiment, the present invention also comprises a jack support connected to the base frame, the jack support comprising a support member slidably housed within a sleeve, the support member capable of extending the jack support to a predetermined length, the support member at one end pivotally connected to a base capable of engaging the ground.

In yet another aspect, the present invention is a method of handling a container comprising the steps of: a) positioning a trailer adjacent to the container, the trailer comprising a base frame, an upper frame comprising a rear end, a forward end, and means to slidably move a container along the length of the upper frame, the upper frame pivotally connected about a pivot point to the base frame, a winch assembly secured to the upper frame, and a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground, and wherein the container comprises a plurality of side walls, a roof, a floor, and a plurality of wheels connected to an exterior portion of the floor; b) tilting the upper frame to the tilted position where the rear end is positioned adjacent to the ground; c) engaging the container with the slidably moving means of the upper frame; d) securing a winch line at one end to the container and at another end to a winch drum, the winch assembly comprising the winch line and the winch drum; e) activating the winch assembly to actuate loading of the container onto the upper frame through use of the slidably moving means; and f) loading the container onto the upper frame.

In one embodiment, the slidably moving means comprises a channel to operably engage a wheel secured to the container when the upper frame is in the tilted position. In yet another embodiment, the present invention additionally comprises the step of positioning the upper frame in a generally horizontal position relative to the base frame after the container is loaded onto the upper frame. In a further embodiment, the trailer further comprises a jack support connected to the base frame, the jack support comprising a support member slidably housed within a sleeve, the support member capable of extending the jack support to a predetermined length, the support member at one end pivotally connected to a base capable of engaging the ground.

### BRIEF DESCRIPTION OF THE DRAWINGS

FIG. 1 is a side view of a utility trailer according to one embodiment of the present invention in a transport position.

FIG. 2 is a bottom view of the utility trailer of FIG. 1.

FIG. 3 is a side view of the utility trailer of FIG. 1 in a loading/unloading position.

FIG. 4 is a rear perspective view of the utility trailer of FIG. 1 in the transport position.

FIG. 5 is a side view of the utility trailer of FIG. 1 in the loading/unloading position wherein a modular container is being loaded onto the utility trailer according to one embodiment of the present invention.

FIG. 6 is a close-up detailed view of the wheels of the modular container operatively engaging a guide channel of the utility trailer of FIG. 1 during a loading/unloading procedure according to one aspect of the present invention.

FIG. 7 is a side view of a modular container according to one embodiment of the present invention;

FIG. 8 is a rear view of the modular container of FIG. 7.

FIG. 9 is a side view of the utility trailer of FIG. 1 in the transport position wherein the modular container is fully loaded onto the utility trailer according to one embodiment of the present invention.

FIG. 10 is a rear perspective view of a modular and collapsible container according to another embodiment of the present invention in an assembled state.

FIG. 11 is a bottom perspective view of the roof section of the modular and collapsible container of FIG. 10.

FIG. 12 is a top perspective view of the floor section of the modular and collapsible container of FIG. 10.

FIG. 13 is a side view of the modular and collapsible container in a disassembled/package state for shipping and/or transport.

FIG. 14 is a cross-sectional view along line XIV-XIV of FIG. 13 of the modular and collapsible container in the disassembled/package state.

### DETAILED DESCRIPTION OF THE INVENTION

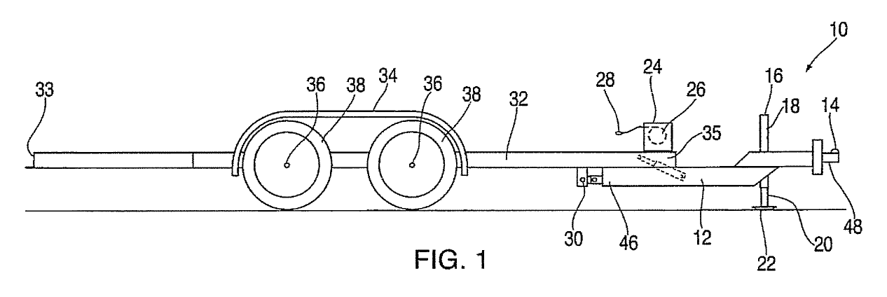

As explained in more detail below and referring to FIGS. 1-6, in one embodiment the present invention generally comprises a trailer frame 10 pivotally connected to an upper frame 32 along the intermediate length of the upper frame 32. In one embodiment, a container 50 having castors 6 attached thereto can be removably secured to the upper frame 32.

FIG. 1 illustrates the trailer frame 10 of the present invention, which is designed to be pulled by a conventional car, truck or other vehicle. The trailer 10 includes a base frame 12 comprised of generally longitudinal extending members 80, 86 interconnected through generally horizontal bisecting members 82, 84, 88, 90. The longitudinal extending members 80, 86 and horizontal bisecting members 82, 84, 88, 90 can be of any desired configuration. In addition to such members, however, the base frame 12 can be comprised of other structural members as desired or required to support a load thereon.

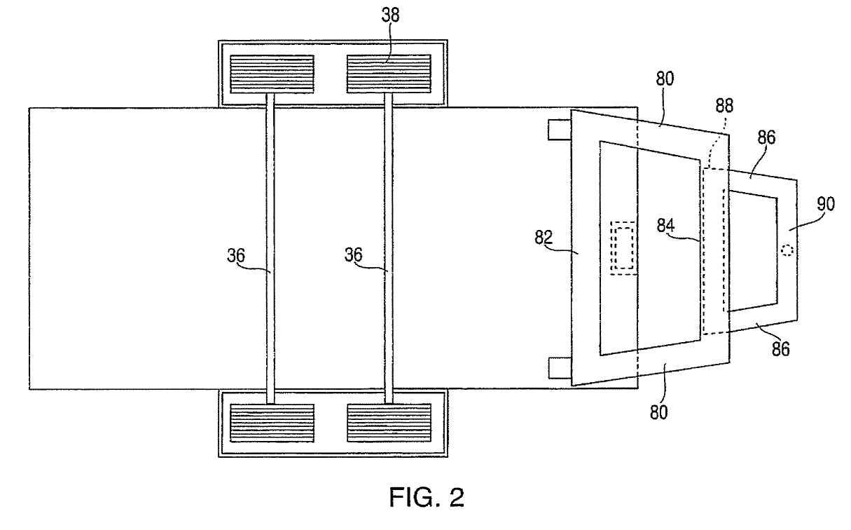

Referring to FIG. 2, however, in a preferred embodiment, the base frame 12 comprises two first opposed and generally longitudinal members 80 bisected by a first horizontal member 82 at their rearward end and a second horizontal member 84 at their forward end. The second horizontal member 84 is shorter in length than the first horizontal member 86 which has the effect of causing the first opposed longitudinal members 80 to slant. The first opposed longitudinal members 80, second horizontal member 84 and first horizontal member 86 are interconnected in such a way as to generally form a trapezoid shape. A third horizontal member 88 is secured to the upper portion of the second horizontal member 84 in an overlapping fashion, the third horizontal member 88 equal to or slightly shorter in length than the second horizontal member 84. Two second opposed longitudinal members 86 at their rearward ends are connected to the third horizontal member 88. The second opposed longitudinal members 86 at their forward ends are then connected to a fourth horizontal member 90, the fourth horizontal member 90 shorter in length than the third horizontal member 88. The second opposed longitudinal members 86, third horizontal member 88 and fourth horizontal member 90 are interconnected in such a way as to generally form a trapezoid shape.

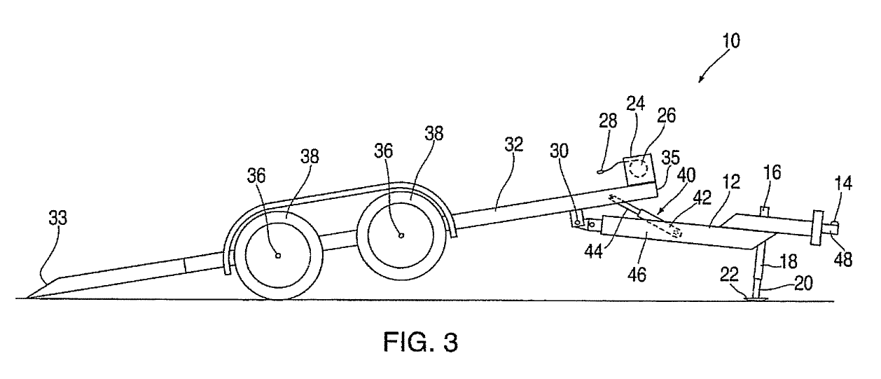

Referring to FIGS. 1 and 3, the base frame 12 has a front end 48 and a rear end 46. The front end 48 is capable of being removably secured to a portion of a vehicle (not shown) using a hitch 14 positioned on the front end of the base frame 12. In one embodiment, a jack support 16 is operably connected to the base frame 12. The jack support 16 comprises a sleeve 18, a support member 20 partially or fully housed within the sleeve 18, and a base 22 to engage the ground or other supporting reference such as a platform. Preferably, the support jack 16 is located substantially central to the base frame 12 such that both the second horizontal member 84 and the third horizontal member 88 are operably connected to the jack support 16. In use, the base 22 is pivotally connected to the support member 20 so that the base 22 can substantially engage the ground even when the support member 20 is positioned at different angles relative to the ground or the base 22. The support member 20 is capable of being extended from within the sleeve 18 to a length that allows the base to substantially engage the ground, a platform, or the like.

As will be explained in greater detail below, the jack support 16 can be extended using the support member 20 (preferably when the upper frame 32 is tilted in relation to the base frame 12 because the jack support 16 can provide extra support for the trailer frame 10). The support member 20 can otherwise partially retract within the sleeve 18 such that the base 22 does not engage the ground, which is important when the trailer frame 10 with or without container 50 is moving or being towed by a vehicle.

Referring back to the base frame 12, the rear end 46 of the base frame 12 is pivotally connected at pivot point 30 to an upper frame 32 along the intermediate length of upper frame 32. The upper frame 32 is comprised of longitudinal extending members interconnected through generally horizontal bisecting members, the interconnected upper frame members forming a substantially rectangular arrangement having a forward end 35 and a rear end 33. It is understood, however, that the upper frame 32 can be comprised of other structural members as desired or required to support a load thereon. Optionally, a upper frame support surface can be secured to the interconnected upper frame members to provide added support for items loaded onto the upper frame 32.

The upper frame 32 incorporates a pair of spaced axles 36 having dual wheels 38 on both ends of the axles 36. A suspension assembly (not shown) is capable of operably supporting and connecting the axles 36 such that the dual wheels 38 are provided on both sides of the upper frame 32. The upper frame 32 can also incorporate a winch assembly 24. The winch assembly 24 comprises a winch wire 28 that can be wound around a winch drum 26, the winch wire 28 capable of extending in length past the length of the upper frame 32 and being secured to a container 50 or the like. The winch assembly 24 can be powered using an electrical source from an associated vehicle or through a separate power source. Alternatively, the winch assembly can be operated manually.

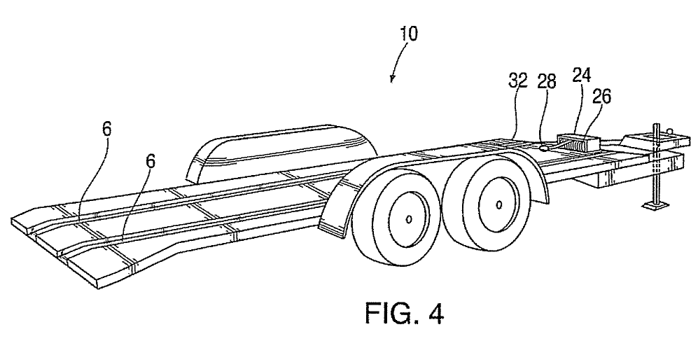

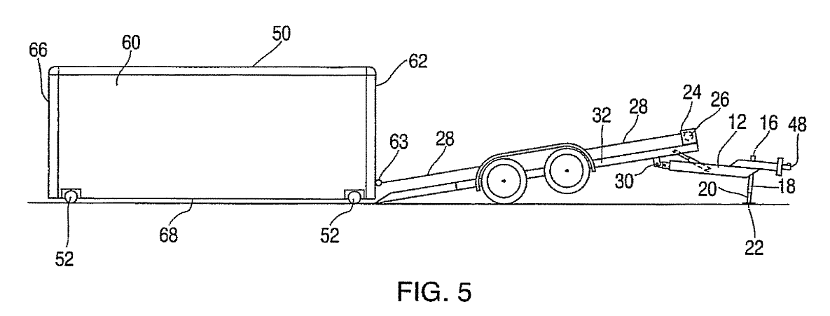

The upper frame 32 also incorporates slidably moving means to move the container 50, the slidably moving means comprising, in a preferred embodiment as illustrated in FIGS. 4 and 5, two channels 6 that extend parallel along the length of upper frame 32. The channels 6 are preferably 1-5 inches deep and 1-5 inches wide. However, any depth and width of the channels 6 may be incorporated in the upper frame 32 that corresponds to castors 52 attached to the container 50, which, when the castors 52 are engaged with the channels 6, actuate movement of the container 50 along the length of the upper frame 32 for loading and loading of the container 50. Although, in the preferred embodiment, two channels 6 are described, it is also within the scope of the invention to have only one channel or a plurality of channels, so long as the channel or channels in conjunction with the castors 52 actuate movement of the container 50 along the length of the upper frame 32. It is also within the scope of the invention to provide for other ways to actuate movement of the container 50 along the length of the upper frame 32 for loading and unloading. The upper frame 32 can incorporate one or more propulsion tracks that engages a bottom portion of the container in a way such that the storage unit is propelled in a predetermined direction. The propulsion track can be comprised of a material which is preferably flexible yet sturdy enough to maintain engagement of the container. Material may include but is not limited to vulcanized rubber, steel, aluminum or composites. Such propulsion tracks are similar in operation to tank treads and may optionally have projecting cleats which will engage a bottom portion of the container and aid in propelling or driving the unit in a desired direction.

A hydraulic assembly 40 as shown is FIGS. 3 and 5, comprised of a hydraulic cylinder 42 and a piston rod 44 capable of extending from the hydraulic cylinder 42, is operably and pivotally mounted between the upper frame 32 and base frame 12. The extension and retraction of the piston rod 44 from the hydraulic cylinder 42 enable the upper frame 32 to be moved between a first position (as illustrated in FIG. 1) and a second position (as illustrated in FIG. 3) relative to the base frame 12. More specifically, the upper frame 32 is pivotally connected to the base frame 12 such that the upper frame 32 can tilt from a first position, the length of which is substantially parallel to the length of the base frame 12, to a second position where the rear end 33 of the upper frame 32 can engage or be in close proximity to the ground or the like. The hydraulic assembly 40 can be of any variety including but not limited to a pneumatic hydraulic assembly or, in a preferred embodiment, a powered hydraulic assembly.

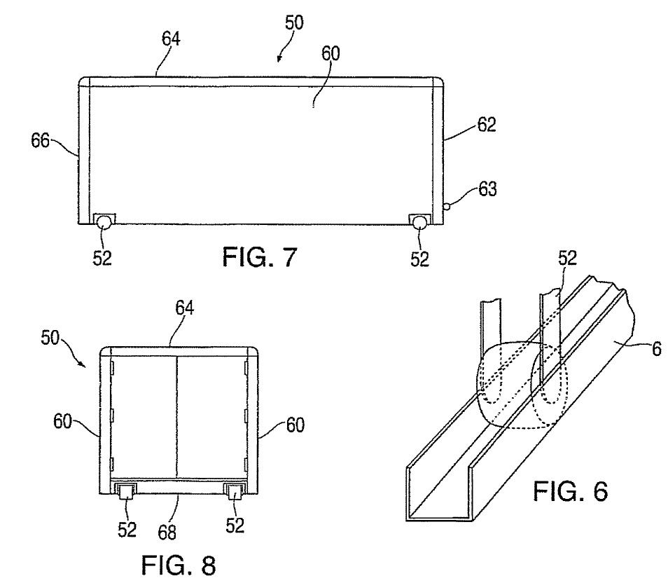

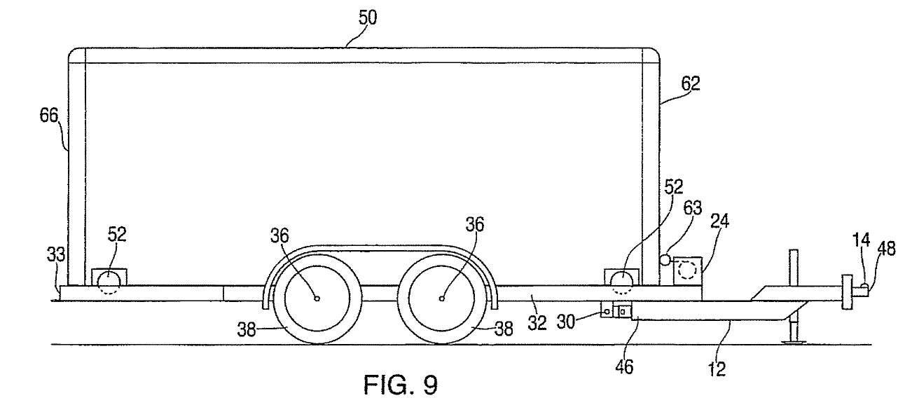

Referring to FIG. 5, in the second position, a container 50 that is located at or in close proximity to ground level can be easily loaded onto the upper frame 32. A forward portion of the container 50 engages the rear end 33 of the upper frame 32. Referring to FIG. 6, castors 52 attached to the bottom of the container 50 engage the channels 6, where the castors 52 moving along the channel allow for the container 50 to be displaced along the length of the upper frame 32. The loading of the container 50 is performed using the winch assembly 24 where the winch wire 28 is extended to reach and to be secured to the container 50, preferably, close to the base of the container 50. The winch assembly 24 is then activated and the winch drum 26 spools the winch wire 28 back along with the container 50 towards the winch assembly 24. Unloading the container 50 can also be performed in a similar fashion where the winch drum 26 unspools the winch wire 28 from the winch assembly 24 at a controlled rate. Aided by the effect of gravity, the container 50 can roll down the length of the upper frame 32, which is in the tilted position, through use of the castors 52 operatively engaging the channels 6.

The container 50 is comprised of two side walls 60, a front wall 62 having a securing device 63 to secure the winch wire 28, a rear wall 66, a roof 64 and a floor 68. The rear wall 66 may be comprised of a door, a plurality of doors, sealable apertures or the like. In the preferred embodiment, the container 50 of present invention is substantially formed as a single piece in order to minimize the occurrence of breaches in the protective covering afforded by the container 50. It is within the scope of the present invention, however, to include a container 50 that is constructed in a modular fashion that may include individually formed walls 60, 62, 66, roof 64, floor 68 or a combination thereof and that are joined together through a variety of methods including but not limited to welding. The container 50 can be constructed of material that protects the contents of the trailer, such as fiberglass, aluminum, metal, composites or other suitable materials. The shape of the container 50 can be any shape suitable for enclosing and protecting its contents. Furthermore, the container 50 may incorporate a variety of devices to facilitate movement of the storage unit including, but not limited to, skids, castors, steel bearing wheels, omni wheels, or other suitable devices. Preferably, castors 52 are located on the underside of the container 50, secured to the exposed exterior portion of the floor 68. It is preferred that four casters 52 are positioned generally around the four corners of the floor 68 such that the pair of castors 52 running along the length of the container are in line with one of the channels 6.

The container 50 allows for storage of items when the container is either loaded onto the trailer frame 10 or when the container unit is not loaded onto and separate from the trailer frame 10 as a stand-alone unit. Furthermore, the trailer frame 10 and container 50 of the present invention affords the user the convenience of placing items within the storage unit at the user's leisure as well as transporting the storage unit at the user's leisure, since the present invention allows for a user to releasably attach the utility trailer to a vehicle for towing. Accordingly, the user does not have to drive or hire a third party to drive bulky storage trucks or the like and may, instead, utilize the user's private vehicle or a similar type of vehicle. Additionally, the user does not have to rely on a storage container moving services, which are many times unreliable and are limited in their availability.

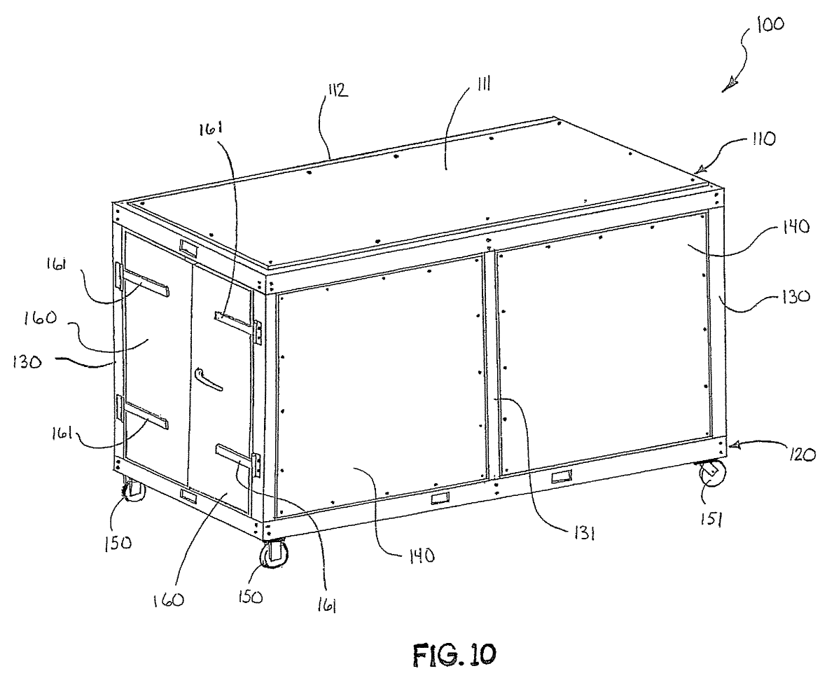

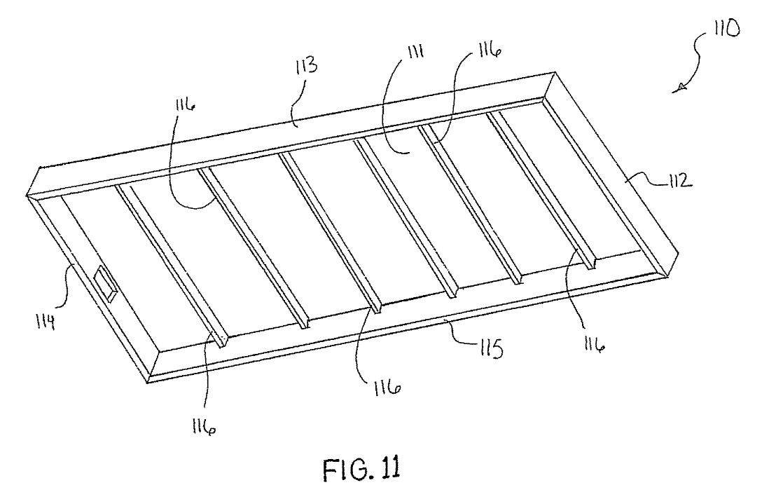

Referring now to FIG. 10, an alternative embodiment of a container 100 that can be used in conjunction with the trailer 10 and methods described above is illustrated. It is to be understood that in some aspects the container 100 itself can constitute an embodiment of the present invention while. The container 100 is a modular and collapsible apparatus that can be used for storage and transport of articles when assembled and can be self-contained kit when disassembled.

In FIG. 10, the container 100 is illustrated in the assembled state. The container 100 generally comprises a roof panel assembly 110, a floor panel assembly 120, a plurality of posts 130-131, a plurality of wall panels 140, a plurality of casters 150 and two doors 160. When in the assembled state, the roof panel assembly 110, the floor panel assembly 120, the plurality of posts 130-131, the plurality of wall panels 140, the plurality of casters 150 and the two doors 160 are removable secured together (as illustrated) to form a stand-alone modular container 10 having a substantially enclosed volume for receiving articles for transport or storage. The removable connection between components can be achieved by screws, nuts and bolts, tab-slot mating, flange-groove interlock techniques or combinations thereof.

The roof panel assembly 110 is connected to the floor panel assembly 120 by a plurality of vertical posts 130-131. More specifically, the tope ends of the posts 130-131 are removably secured to the roof panel assembly 110 while the bottom ends of the posts 130-131 are removably secured to the floor panel assembly 120. Preferably there are four corner posts 130 removably connected at the corners of the roof and floor panel assemblies 110, 120. Two center posts 131 are removably connected at the mid-point length of the roof and floor panel assemblies 110, 120. Of course, any number and positioning of posts can be used. Together, the roof panel assembly 110, the floor panel assembly 120 and the posts 130-131 form the framework structure for the container 100. Optionally, rub rails (not visible) can be connected to the posts 130-131 in a horizontal arrangement along the length of the container's interior volume.

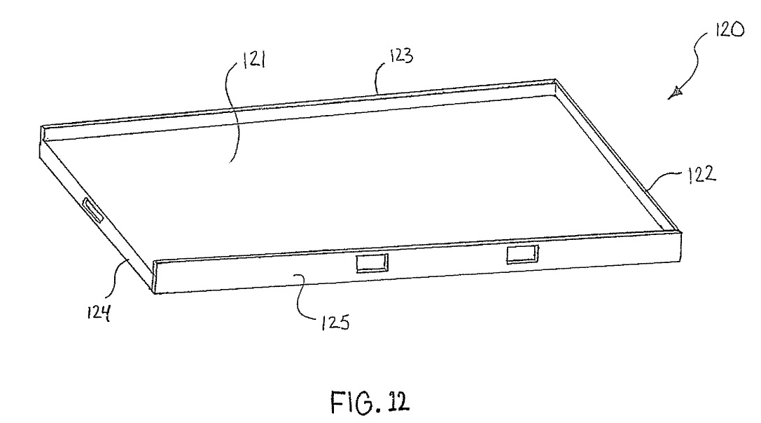

A plurality of wall panels 140 are removably secured to the framework 110, 120, 130-131 to provide housing and protection (e.g., protection from external elements such as wind, rain and sun) for contents within the container 100. The panels can be removably secured to the vertical posts 130-131 via bolts or other means. Similarly, a roof panel 111 and a floor panel 121 (FIG. 12) are also be removably secured to the perimeter frames of the roof and floor panel assemblies 110, 120.

The vertical members can be constructed of any suitable materials including but not limited to steel, aluminum, any other metal or composites thereof, plastic, wood or any other suitable material. Preferably the panels are made from a lightweight, flexible materials including but not limited to fiberglass, aluminum, plastic and the like.

The container 100 also comprises two doors 160 having hinges 161. The hinges 161 are removably secured to the rear corner posts 130 to form the back wall of the container 100. The hinges facilitate pivotal connection between the doors and the posts 130 for opening and closing.

Preferably, all bolt holes are pre-drilled in the posts 130-131, panel assemblies 110, 120, panels 140 and other components of the container 100 to facilitate ease of assembly.

Referring now to FIG. 1, the roof panel assembly 10 is illustrated from beneath. The roof panel assembly 110 is preferably provided as a single component. The roof panel assembly comprises a perimeter frame consisting of beams 112-115. The roof panel assembly 110 likewise comprises joist/bow members 116 connecting and traversing the (lateral) perimeter beams 113, 115 for structural integrity. Preferably, all connections between the beams 112-115 and the joist members 116 are welded. The roof panel 111 is connected by fasteners or the like atop the framework created by the beams 112-115 and the joist members 116, such as rivets, bolts, screws, etc. Of course, other connection techniques can be used.

The perimeter beams 112-115 form a ridge surrounding and extending downward from the bottom surface of the roof panel 111. Importantly, the roof joists 116 have a height that is less than the height of the perimeter beams 112-115. As will be described below, this is important for shipping the container 100 as a kit. If desired, the perimeter beams 112-115 can have a flange at their edges or other structural and functional details such as slots, C-channels, holes, etc for facilitating removable connections or stacking.

Referring now to FIG. 12, the floor panel assembly 120 is illustrated from above. The floor panel assembly 120 is preferably provided as a single component. The floor panel assembly 120 comprises a perimeter frame consisting of beams 122-125. The roof panel assembly 120 likewise comprises joist/bow members (not visible) connecting and traversing the (lateral) perimeter beams 123, 125 for structural integrity. Preferably, all connections between the beams 122-125 and the floor joist members are welded. A floor panel 121 is connected by fasteners or the like atop the framework created by the floor joists and nests within the beams 122-125. Rivets, bolts, screws, or other connection techniques can be used.

The perimeter beams 122-125 form a ridge surrounding and extending upward from the top surface of the floor panel 121. Importantly, the floor joists (not visible) have a height that is less than the height of the perimeter beams 122-125. As will be described below, this is important for shipping the container 100 as a kit. If desired, the perimeter beams 122-125 can have a flange at their edges or other structural and functional details such as slots, C-channels, holes, etc for facilitating removable connections o stacking.

It is preferred that the modular container 100 may be delivered as a kit, which may be transported in conjunction with the trailer described above.

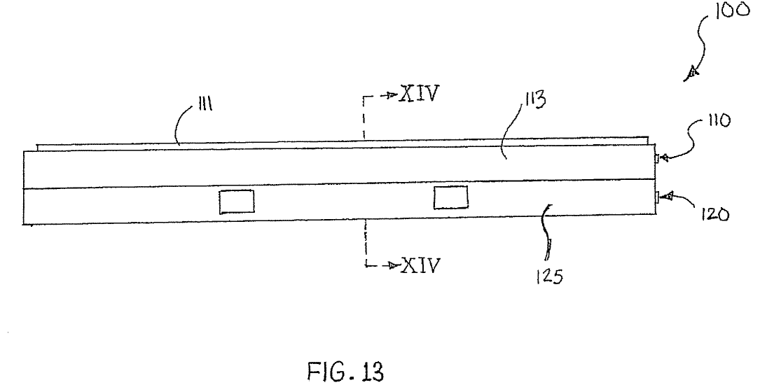

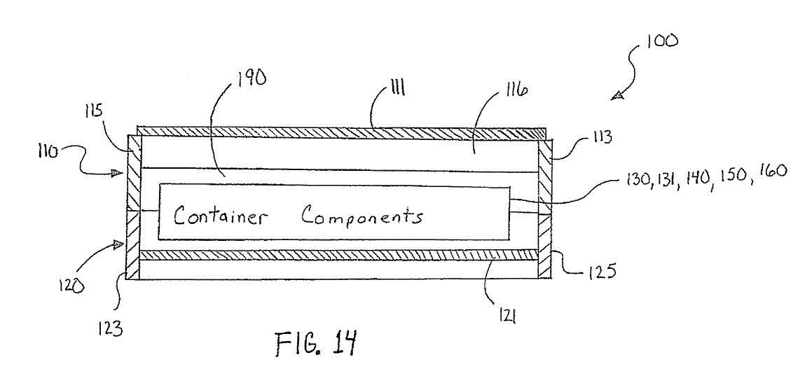

Referring now to FIGS. 13-14 concurrently, the modular container 100 is illustrated in a disassembled state and packaged as an easily transportable fully self-contained kit. When in the disassembled state, the roof panel assembly 110 is stacked atop the floor panel assembly 120 as illustrated, thereby forming a cavity 190 between the floor panel 121 and the roof panel 111. In a preferred embodiment, the height of the stacked panel assemblies 110, 120 combined are less than or equal to 10 inches.

The cavity 190 is sufficiently large enough to accommodate all of the remaining components of the container 100, including the posts 130-131, doors 160, panels 140, casters 150, and all necessary hardware (generically illustrated as a box). Thus, the entirety of the remaining components of the container 100 are located within the spaced formed by the housing formed by the floor and roof panel assemblies 110, 120. In other words, the panels and posts are sandwiched between the stacked floor and roof panel assemblies 110, 120 such that the total height of the entire kit does not exceed 10 inches. The modular container in this preferred embodiment can be assembled in less than two hours by two technicians.

Approximately 19-21 modular container kits 100 can be delivered on a conventional tractor trailer bed (3 stacks of approximately 7 modular container kits each). As stated above, the container kits are devised of vertical members, support posts and “panels.” The upper and bottom panels all come to be aligned and assembled using support posts The composite panel inserts slip into place to completely enclose the unit. In such an embodiment, the modular container is assembled quickly using bolts and screws. This simplified design saves time and product weight. (Which addresses problem typical of prior art containers, which are assembled using six panels-top, bottom, side walls, door(s) and end wall. The modular container according to the preferred embodiment of the present invention, however, utilizes only two complete panels and upright supporting posts.)

Multiple bottom and upper panels can be stacked on top of each other to minimize container space when more than one modular container is being utilized. Vertical members can also be stored adjacent to or within the stacked upper and bottom panels. Panels can likewise be contained within or placed on top of the stacked bottom and upper panels.

Such ease of storage allows a user to store and utilize multiple modular containers when desired, as well as facilitates the ease by which a user can move/transport goods. For example, when a user has a need to move a substantial amount of goods, such user is capable of assembling the desired number of modular containers and storing the user's goods in the modular containers. Then, using the trailer assembly of the present invention, the user can transport each modular container to a desired site until all the modular containers have been moved to such site. The user can then remove all the goods from the modular containers. At this point, however, the user need not move each empty modular container back to the original site. Instead, the user can disassemble the modular containers, stack the parts thereof, and transport more than one, substantially all, or all of the modular containers back to the original site, thus, saving valuable time and effort.

The present invention has been described in relation to the accompanying drawings; however, it should be understood that other and further modifications, apart from those shown or suggested herein, may be made within the spirit and scope of the present invention. It is also intended that all matter contained in the foregoing description or shown in the accompanying drawings shall be interpreted as illustrative rather than limiting.

What is claimed is:

1. A modular container capable of being secured to a trailer base and having an assembled state and disassembled state, the modular container comprising:
a bottom panel assembly;
an upper panel assembly removably stacked atop the bottom panel assembly to form a cavity when the modular container is in the disassembled state;
at least one post comprising a first end and a second end, wherein the at least one post is capable of (i) being substantially contained within the cavity between the bottom panel assembly and the upper panel assembly when the modular container is in the disassembled state and (ii) being removably secured to the upper panel assembly at the first end and to the bottom panel assembly at the second end when the modular container is in the assembled state; and
a plurality of panels capable of (i) being substantially contained within the cavity between the bottom panel assembly and the upper panel assembly when the modular container is in the disassembled state and (ii) being removably secured to the at least one post, the bottom panel assembly, the upper panel assembly or any combination thereof when the modular container is in the assembled state;
whereby the upper panel assembly, the bottom panel assembly, the plurality of panels and at least one post create a stand-alone modular container defining a substantially enclosed volume when in the assembled state.

2. The modular container of claim 1 further comprising casters operably connected to the bottom panel assembly or the at least one post.

3. The modular container of claim 1 wherein the height of the container in the disassembled state is less than 10 inches.

4. A system for storing and/or transporting articles comprising:
a modular container comprising:
a bottom panel assembly;
an upper panel assembly removably stacked atop the bottom panel assembly to form a cavity when the modular container is in a disassembled state;
at least one post comprising a first end and a second end, wherein the at least one post is capable of (i) being substantially contained within the cavity between the bottom panel assembly and the upper panel assembly when the modular container is in the disassembled state and (ii) being removably secured to the upper panel assembly at the first end and to the bottom panel assembly at the second end when the modular container is in an assembled state; and
a plurality of panels capable of (i) being substantially contained within the cavity between the bottom panel assembly and the upper panel assembly when the modular container is in the disassembled state and (ii) being removably secured to the at least one post, the bottom panel assembly, the upper panel assembly or any combination thereof when the modular container is in the assembled state;
whereby the upper panel assembly, the bottom panel assembly, the plurality of panels and at least one post create a stand-alone modular container defining a substantially enclosed volume when in the assembled state; and
a trailer comprising:
a base frame;
an upper frame comprising a rear end, a forward end, and slidably moving means to move the modular container in the assembled state along the length of the upper frame, the upper frame pivotally connected about a pivot point to the base frame;
a winch assembly secured to the upper frame; and
a hydraulic assembly pivotally mounted between the base frame and the upper frame, the hydraulic assembly adapted to move the upper frame relative to the base frame about the pivot point between a generally horizontal position and a tilted position,
wherein the upper frame in the tilted position is adapted to receive the modular container in the assembled state through the slidably moving means.

5. The trailer of claim 4, wherein the hydraulic assembly comprises a powered hydraulic cylinder and a piston rod operably connected to the powered hydraulic cylinder, the piston rod capable of being extended from the powered hydraulic cylinder.

6. The trailer of claim 4, wherein the slidably moving means comprises a channel to operably engage a wheel secured to the container when the upper frame is in the tilted position.

7. The trailer of claim 6, wherein the winch assembly comprises a winch wire operably connected to a winch drum, the winch wire having a first end and a second end, wherein the winch wire at the first end is operably connected to the winch drum, the second end capable of being removably secured to the container, whereby the winch assembly actuates loading of the container onto the upper frame.

8. The trailer of claim 6, wherein the slidably moving means comprises two channels, each of the two channel capable of operably engaging a wheel secured to the container when the upper frame is in the tilted position.

9. A container kit having an assembled state and disassembled state comprising:
a floor section comprising a floor panel and a first perimeter frame connected to the floor panel so as to form a ridge extending above a surface of the floor panel;
a roof section comprising a roof panel and a second perimeter frame connected to the roof panel so as to form a ridge extending below a surface of the floor panel;
a plurality of posts comprising a first end and a second end;
a plurality of panels;
at least one door having hinges;
a plurality of wheels;
wherein when the container kit is in the disassembled state, the roof section stacks atop the floor section forming a cavity between the floor panel and the roof panel, and the plurality of posts, the plurality of panels, the at least one door, and the plurality of wheels are positioned within the cavity; and
wherein when the container kit is in the assembled state, the floor section, the roof section, the plurality of posts, the plurality of panels, the at least one door, and the plurality of wheels form a stand-alone container defining a substantially enclosed volume.

10. The container kit of claim 9 further comprising hardware for facilitating assembly of the stand-alone container, the hardware positioned within the cavity when the container kit is in the disassembled state.

11. The container kit of claim 9 wherein when the container kit is in the assembled state, (i) the first ends of the plurality posts are removably connected to the floor section and the second ends of the plurality posts are removable connected to the roof section so as to form a frame structure; (ii) the plurality of panels are removably connected to the frame structure; (ii) the at least one door is pivotally connected to the frame structure; and (iv) the plurality of wheels are removably connected to the floor section.

12. The container kit of claim 11 wherein the first and second ends of the plurality posts are removably connected to the floor and roof sections by a combination of bolts and channel-flange interlock.

13. The container kit of claim 9 wherein when the container kit is in the disassembled state and the roof section is stacked atop the floor section, the ridge of the roof section is in contact with the ridge of the floor section.

14. The container kit of claim 9 wherein the plurality of wheels comprises two fixed direction casters and two swiveling casters.

15. The container kit of claim 9 further comprising:
a plurality of rub rails;
wherein when the container kit is in the disassembled state, the plurality of rub rails are positioned within the cavity; and
wherein when the container kit is in the assembled state, the plurality of rub rails are removably connected to the plurality of posts.

16. A system for storing and/or transporting articles comprising:
a container kit comprising:
a floor section comprising a floor panel and a first perimeter frame connected to the floor panel so as to form a ridge extending above a surface of the floor panel;
a roof section comprising a roof panel and a second perimeter frame connected to the roof panel so as to form a ridge extending below a surface of the floor panel;
a plurality of posts comprising a first end and a second end;
a plurality of panels;
at least one door having hinges;
a plurality of wheels;
wherein when the container kit is in a disassembled state, the roof section stacks atop the floor section forming a cavity between the floor panel and the roof panel, and the plurality of posts, the plurality of panels, the at least one door, and the plurality of wheels are positioned within the cavity; and
wherein when the container kit is in an assembled state, the floor section, the roof section, the plurality of posts, the plurality of panels, the at least one door, and the plurality of wheels form a stand-alone container defining a substantially enclosed volume; and
a trailer comprising:
a base frame;
an upper frame comprising a rear end, a forward end, and a support surface, the upper frame pivotally connected about a pivot point to the base frame;
at least two channels in the support surface for engaging the plurality of wheels of the stand-alone container, the at least two channels extending from at or near the rear end of the upper frame to at or near the forward end of the upper frame;
a winch assembly secured to the upper frame;
a hydraulic assembly comprising a piston rod and a powered hydraulic cylinder, the hydraulic assembly mounted between the base frame and the upper frame so that the piston rod is connected to the upper frame at or near the forward end and the-powered hydraulic cylinder is connected to the base frame, the hydraulic assembly adapted to move the upper frame about the pivot point between a generally horizontal position and a tilted position;
a first set of wheels and a second set of wheels connected to the upper frame, the first set of wheels contacting a ground surface both when the upper frame is in the generally horizontal position and when the tipper frame is in the tilted position.

17. The system of claim 16 wherein the hydraulic assembly is positioned so that the piston rod is angled in a direction from: the rear end of the upper frame to the forward end of the upper frame.

18. The system of claim 16 wherein when the container kit is in the assembled state, (i) the first ends of the plurality posts are removably connected to the floor section and the second ends of the plurality posts are removable connected to the roof section so as to form a frame structure; (ii) the plurality of panels are removably connected to the frame structure; (ii) the at least one door is pivotally connected to the frame structure; and (iv) the plurality of wheels are removably connected to the floor section.

19. The system of claim 18 wherein the first and second ends of the plurality posts are removably connected to the floor and roof sections by a combination of bolts and channel-flange interlock.

20. The system of claim 16 wherein when the container kit is in the disassembled state and the roof section is stacked atop the floor section, the ridge of the roof section is in contact with the ridge of the floor section.
